(19) United States
(12) Patent Application Publication
(10) Pub. No.: US 2009/0002535 A1
(43) Pub. Date: Jan. 1, 2009

(54) OFFSET-COMPENSATED SELF-RESET CMOS IMAGE SENSORS

(75) Inventors: Dongwon Park, Cupertino, CA (US); Youngjoong Joo, Chandler, AZ (US)

Correspondence Address: FULBRIGHT & JAWORSKI L.L.P., 600 CONGRESS AVE., SUITE 2400, AUSTIN, TX, 78701, US

(73) Assignee: Arizona Board of Regents on behalf of Arizona State University, Scottsdale, AZ (US)

(21) Appl. No.: 12/146,966

(22) Filed: Jun. 26, 2008

Related U.S. Application Data
(60) Provisional application No. 60/946,691, filed on Jun. 27, 2007.

(51) Int. Cl. H01L 31/112; H04N 5/335

(52) U.S. Cl. 348/308; 257/292; 257/E31.079; 348/E05.091

(57) ABSTRACT

Devices and methods for improving the dynamic range and signal-to-noise ratio of image sensors. Complementary Metal Oxide Semiconductor (CMOS) image sensors that use at least one CMOS image pixel circuit, and methods that the CMOS image sensor integrated circuit is configured to perform.

### CROSS REFERENCE TO RELATED APPLICATION

This application claims priority to U.S. Provisional Patent Application Ser. No. 60/946,691, filed Jun. 27, 2007 which is incorporated by reference.

### BACKGROUND

1. Field of the Invention

This invention relates to wide dynamic range sensors, and more particularly to Complementary Metal Oxide Semiconductor (CMOS) image sensors with improved dynamic range and signal to noise ratio.

2. Description of the Related Art

Complementary Metal Oxide Semiconductor (CMOS) image sensors are the subject of significant research and development, attracting attention in the field of electronic imaging that has previously been dominated by charge-coupled devices (CCDs). This is due to some of the performance benefits of CMOS, such as the ability to handle a wider dynamic range (DR) of optical intensity than CCDs, as well as economic considerations.

An important requirement in image sensor specification is dynamic range (DR). This specification is broadly applicable to a range of sensing devices. Various techniques to improve the DR of image sensors have been developed. However, many of them have limitations of its DR mainly due to limited well capacity of a photodetector, with respect to its readout scheme.

Self-reset techniques are one method to overcome this limitation and achieve both DR and signal-to-noise ratio (SNR) improvements. By allowing asynchronous reset of the photodetector independently, each pixel of a sensor can accumulate an input signal beyond the well capacity of a conventional pixel of CMOS image sensors. The increased well capacity improves the SNR performance as the incoming light intensity becomes stronger.

Although pixel-level analog to digital conversion (ADC) self-reset CMOS image sensors have been developed, the improvement in SNR is less than the theoretical expectation of 10 dB per decade. These circuits may also require many additional transistors, even when circuit reuse techniques are applied.

### SUMMARY

Devices and methods for improving the dynamic range and signal-to-noise ratio of image sensors are disclosed.

Embodiments of the present disclosure include a CMOS image sensor integrated circuit for characterizing an optical signal. In these embodiments, the CMOS image sensor integrated circuit may have at least one CMOS image pixel circuit. The CMOS image pixel circuit may include a photodetector configured to generate a photodetector output signal in response to the optical signal, a trigger coupled to the photodetector, and a latch coupled to the trigger.

The trigger may be configured to receive a trigger input signal that is a function of the photodetector output signal, and to output a trigger output signal that is a function of the trigger input signal. The latch may configured to store a time information in a data storage that is coupled to the latch. The time information may be a function of time required for the trigger output signal to reach a reset threshold value.

The CMOS image pixel circuit may be configured to perform a photodetector self reset that asynchronously resets the photodetector when the trigger output signal reaches the reset threshold value.

In some embodiments of the present CMOS image sensor integrated circuits, the trigger is a Schmitt trigger. Some embodiments have a trigger that contains six or fewer transistors. In some embodiments, the photodetector self reset is performed within about 6.2 nanoseconds or less from when the output signal reaches the reset threshold value. The self-reset is performed within about 4.6 nanoseconds or less from when the output signal reaches the reset threshold value in some embodiments.

Some embodiments of the CMOS image sensor integrated circuit have a CMOS image pixel circuit that also includes the data storage.

In some embodiments, the CMOS image pixel circuit also includes an offset compensator that is coupled to the photodetector and to the trigger. In these embodiments, the offset compensator may be configured for receiving a calibration signal, and for providing an offset between the photodetector output signal and the trigger input signal. The offset may be a function of the calibration signal. In some embodiments, the offset compensator may have a capacitor.

Some embodiments of the CMOS image sensor integrated circuit have a CMOS image pixel circuit that contains 28 or fewer transistors. In some embodiments, the CMOS image pixel circuit contains 16 or fewer transistors.

Some embodiments of the CMOS image sensor integrated circuit provide signal-to-noise ratio of about 65 dB or higher. Some embodiments provide signal-to-noise ratio of about 79 dB or higher.

Some embodiments of the CMOS image sensor integrated circuit provide dynamic range of about 105 dB or higher. Some embodiments provide dynamic range of about 120 dB or higher.

Embodiments of the present disclosure also include methods for characterizing an optical signal received by a photodetector. These methods may include the steps of generating a photodetector output signal in response to the optical signal; receiving a trigger input signal that is a function of the photodetector output signal and a calibration signal; outputting a trigger output signal that is a function of the trigger input signal; storing a time information that is a function of when the trigger output signal reaches a reset threshold value; and performing a photodetector self reset that is configured to asynchronously reset the photodetector when the trigger output signal reaches the reset threshold value; computing a pixel image signal that is a function of the time information; and outputting the pixel image signal to an external data storage or to a computing device.

In some of these embodiments, the photodetector self reset may be configured to asynchronously reset the photodetector within about 6.2 nanoseconds or less from when the output signal reaches the reset threshold value.

Any embodiment of any of the present devices and methods may consist of or consist essentially of—rather than comprise/include/contain/have—the described functions, steps and/or features. Thus, in any of the claims, the term “consisting of” or “consisting essentially of” may be substituted for any of the open-ended linking verbs recited above, in order to change the scope of a given claim from what it would otherwise be using the open-ended linking verb.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. Thus, a method comprising certain steps is a method that includes at least the recited steps, but is not limited to only possessing the recited steps.

The terms “a” and “an” are defined as one or more than one, unless this application expressly requires otherwise. The term “another” is defined as at least a second or more.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings illustrate by way of example and not limitation. Identical reference numerals do not necessarily indicate an identical structure, system, or display. Rather, the same reference numeral may be used to indicate a similar feature or a feature with similar functionality. Every feature of each embodiment is not always labeled in every figure in which that embodiment appears, in order to keep the figures clear.

FIG. 1 is a graph illustrating reset voltages as a function of time.

FIG. 2 depicts a schematic of an embodiment of a CMOS image pixel circuit according to the present disclosure.

FIGS. 3A and 3B show the layouts of a CMOS image sensor integrated circuit (IC) and of a CMOS image pixel circuit, respectively. The embodiment of the CMOS image sensor integrated circuit depicted in FIG. 3A is a 3 mm by 3 mm IC that includes 768 CMOS image pixel circuits arranged as a 32×24 array. A single instance of an embodiment of the CMOS image pixel circuit that is 49.8 μm×49.8 μm is depicted in FIG. 3B.

FIG. 4 shows simulation results of a CMOS image sensor IC according to an embodiment of the invention.

FIGS. 5A and 5B illustrate the increased dynamic range provided by the present self-resetting image sensors. FIG. 5A depicts the photodetector charge reaching saturation due to the well capacity of the photodetector being reached. FIG. 5B depicts the improved dynamic range of the signal that is achievable by embodiments of the present disclosure. In these embodiments, self-resetting of the CMOS image pixel circuit causes the photodetector to be reset in order to avoid saturation, while an aggregate charge can be determined by using the reset information.

FIG. 6 is a graph that depicts the offset between the photodetector output signal and trigger input signal. Also shown are the photodetector self reset, and reset threshold value.

FIG. 7 presents a comparison of simulation results from an embodiment of the CMOS image sensor IC that is exposed to weak intensity light and to strong intensity light signals.

FIGS. 8A and 8B present a comparison of the reset delay time of a prior comparator-based method (FIG. 8A) and the self-reset delay time of an embodiment of the present methods (FIG. 8B). The delay times of both figures is based on devices implemented using 0.18 μm CMOS fabrication technology.

FIG. 9 depicts the measured dynamic range achieved in an embodiment of the present devices.

FIG. 10 depicts the measured SNR achieved in an embodiment of the present devices.

FIG. 11 presents the measured results of an embodiment image sensors compared with other prior CMOS image sensors.

FIG. 12 is a flow diagram of an embodiment of the present methods.

### DESCRIPTION OF ILLUSTRATIVE EMBODIMENTS

The present invention comprises a novel CMOS image sensor (CIS) integrated circuit (IC) that uses at least one CMOS image pixel circuit, and novel methods that the CMOS image sensor integrated circuit is configured to perform. The following description is presented to enable a person or ordinary skill in the art to make and use the invention. Descriptions of specific applications are provided only as examples. Various modifications to the preferred embodiments will be readily apparent to those skilled in the art with the benefit of this disclosure, and the general principles defined herein may be applied to other embodiments and applications without departing from the spirit and scope of the invention. Thus, the present invention is not intended to be limited to the embodiments shown, but is to be accorded the widest scope consistent with the principles and features disclosed herein.

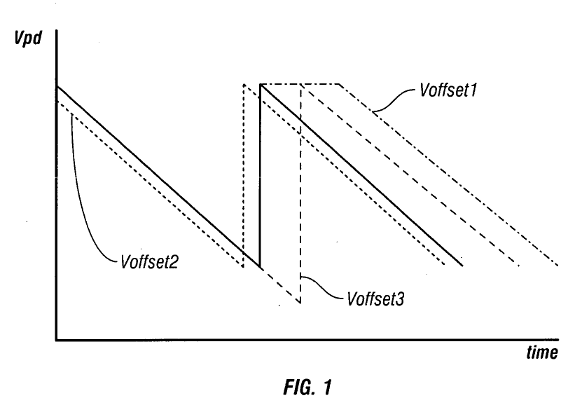

Although pixel-level analog to digital conversion (ADC) self-reset CMOS image sensors have been developed, the improvement in SNR is less than the theoretical expectation of 10 dB per decade. One reason for this is that noise signals and the like can accumulate throughout the pixel plane array, causing changes is offset voltages. Referring to FIG. 1, typical accumulated offsets are depicted resulting from, for example, self-reset time delay offset (V_{offset1}), voltage level difference between global reset and self resets (V_{offset2}), and comparator offset (V_{offset3}). The trace V_{offset1} is due to longer self-reset time duration, V_{offset2} is from voltage mismatch between global reset and self-reset, and V_{offset3} is from pixel-to-pixel comparator offset.

Trigger circuits, including but not limited to Schmitt trigger circuits, can be used in the design of sensors such as CMOS image sensors to provide a simple and robust solution to remove the systematic errors in a self-reset technique. In a trigger circuit, a particular signal function is output when the trigger's input signal reaches a threshold level. For example, a trigger may be configured such that when an input (such as a voltage) is higher than a certain chosen threshold level, the output signal (which may also be a voltage) is high; when the input signal is below another (lower) chosen threshold level, the output signal is low; and when the input is between the two threshold levels, the output retains its present value.

In an exemplary embodiment of the invention, a wide DR and high SNR CMOS image sensor IC is achieved using at least one self-reset CMOS image pixel circuit that includes offset compensation using a trigger circuit, where the trigger circuit is a Schmitt trigger circuit.

Exemplary embodiments of the invention are described below. In one exemplary embodiment, a Schmitt trigger self-reset CMOS image sensor IC having a CMOS image pixel circuit that uses 0.5 μm CMOS technology has been designed and simulated. However, it will be understood that the 0.5 μm CMOS design is used by way of example only, and that CMOS image sensor ICs can be formed using other semiconductor processes, and that other line widths and feature sizes can also be used (for example, a 90 nm CMOS processes). It will also be understood that other trigger circuits and/or offset compensation techniques can be used.

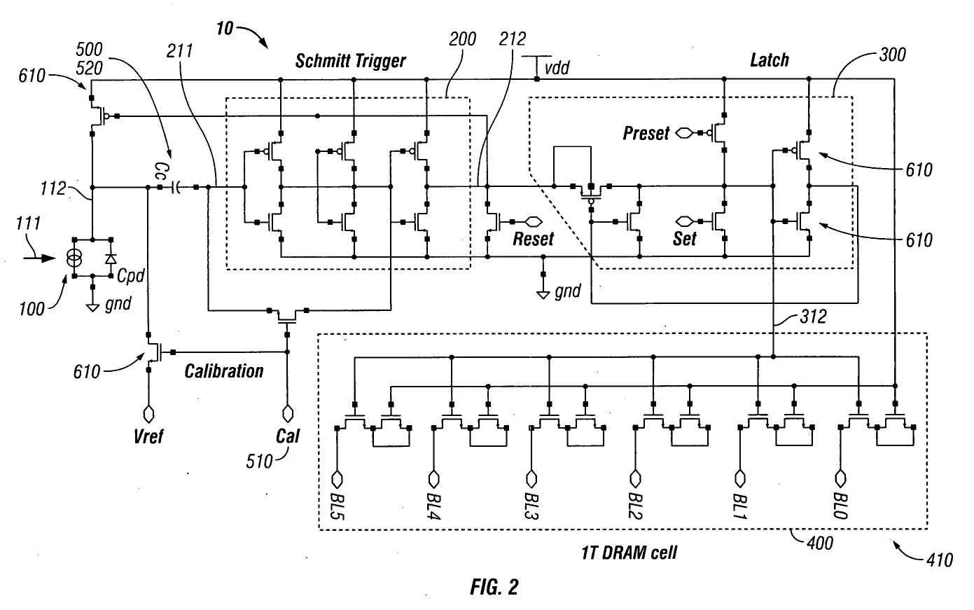

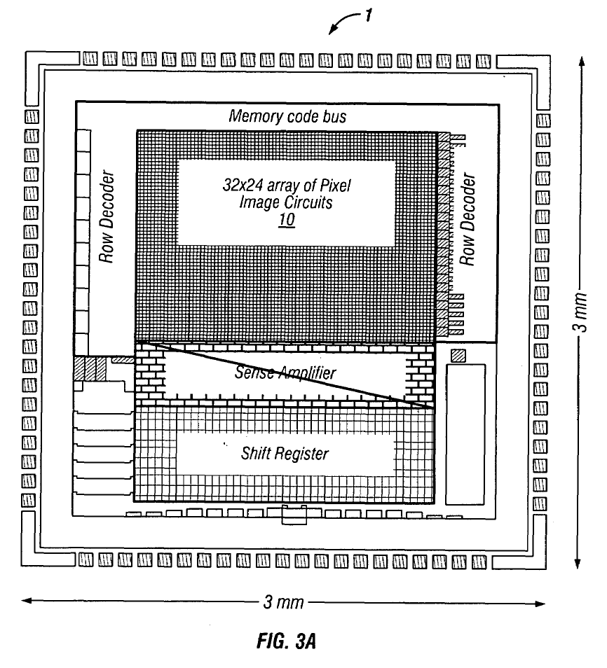

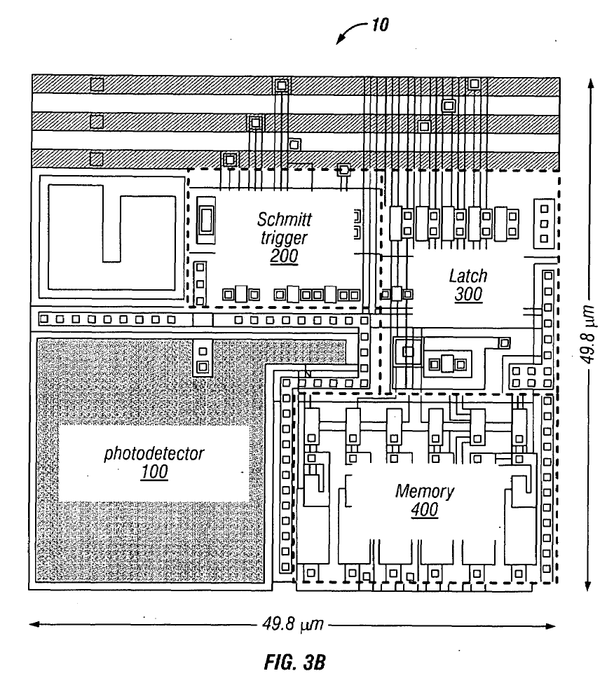

A circuit schematic for an exemplary embodiment of a CMOS pixel is shown in FIG. 2. The circuit (CMOS image pixel circuit 10) consists of 16 transistors (for example, transistor 610), exclusive of the transistors used in the in-pixel memory (data storage 400). One capacitor (capacitor 520) is used in offset compensator 500. The layout for an embodiment of CMOS image pixel circuit 10 that is 49.8 μm×49.8 μm is shown in FIG. 3B. The layout of an embodiment of CMOS image sensor integrated circuit 1 that is a 3 mm by 3 mm IC that includes 768 instances of CMOS image pixel circuit 10 (arranged as a 32×24 array) is depicted in FIG. 3A.

Turning again to FIG. 2, in addition to the photodetector element (photodetector 100), the CMOS image pixel circuit 10 comprises a calibration circuit (offset compensator 500), a trigger circuit (trigger 200, which is a Schmitt trigger in this embodiment), a latch (latch 300), and a memory cell (data storage 400). The in-pixel memory (data storage 400) can be implemented in various ways. In an exemplary embodiment of the invention, 1-transistor dynamic RAM (IT DRAM) is used to increase the pixel's fill factor (that is, the ratio of the active photosensitive area to the total pixel area of CMOS image pixel circuit 10, including all circuitry). The exemplary Schmitt trigger (trigger 200) consists of six transistors and a negative feedback loop with switches added. In the exemplary embodiment, another six transistors are used for a pulse-triggered latch circuit (latch 300).

Initially, the control voltage signal for calibration of the embodiment of CMOS image pixel circuit 10, denoted Cal (calibration signal 510), allows calibrating the Schmitt trigger (trigger 200), and the difference between desired reference voltage, V_{ref}, and switching voltage (the threshold voltage) of the Schmitt trigger is stored in the compensation capacitor, Cc (capacitor 520).

In the exemplary embodiment of CMOS image pixel circuit 10, the control voltage signal denoted Reset makes CMOS image pixel circuit 10 start integration through a similar method to soft self-reset to avoid an error between global reset and self-reset. Once the first self-reset occurs, time information is latched to turn off the memory writing from a memory bus. Preset and Set signals are required for initialization of in-pixel memory (data storage 400).

The operation of the embodiment of CMOS image pixel circuit 10 in response to an optical signal incident on the photodetector (optical signal 111) is now described. Initially, the Reset switch is closed. This allows a capacitor with a capacitance (not shown), associated with and coupled to the photodetector, to be fully charged. This capacitance can include a parasitic capacitance. When the reset switch is opened, the charge is stored on the capacitor. Light incident on the photodetector (optical signal 111) of the CMOS image pixel circuit 10 generates an electrical signal such as a voltage or a current (photodetector output signal 112). The magnitude of the photo-induced electrical signal (photodetector output signal 112) is related to the light intensity (optical signal 111). In some embodiments, the electrical signal (photodetector output signal 112) is a photocurrent that is proportional to the light intensity (optical signal 111). The photocurrent causes the capacitor to discharge. When the voltage across the capacitor coupled to the detector has reduced and reaches the lower switching point of the Schmitt trigger input (trigger input signal 211), a self-reset triggering signal is generated at trigger output signal 212. The triggered signal at trigger output signal 212 is then latched (by latch 300) to store its time information (time information 410) into a corresponding pixel memory (data storage 400) for CMOS image pixel circuit 10.

One possible problem in some embodiments of CMOS image sensor integrated circuit 1 is an offset of the Schmitt trigger input stage which may result in pixel-to-pixel process variation between the plurality of CMOS image pixel circuit 10 within CMOS image sensor integrated circuit 1. Referring to FIG. 2, this offset can be solved using an offset compensator 500 that includes a compensation capacitor (capacitor 520) in front of the Schmitt trigger input node. Offset compensator 500 compensates by creating an offset to trigger input signal 211. The self-reset switching point is calibrated in such a way that the offset is stored in the compensation capacitor (capacitor 520) during calibration before integration starts. It also provides the additional benefit of achieving a wider input swing range by setting the reference voltage, V_{ref}, lower than Schmitt trigger's switching point.

FIG. 6 depicts offset 590 between photodetector output signal 112 and trigger input signal 211. The self-reset switching point is calibrated such that photodetector self reset 110 occurs at reset threshold value 210.

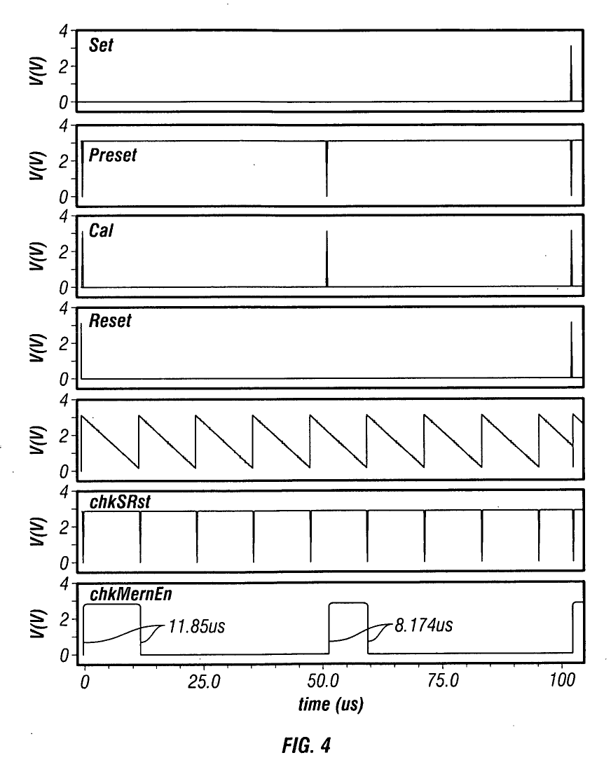

An overall timing diagram for the embodiment shown in FIGS. 2, 3A, and 3B is illustrated in FIG. 4. Vpd, chkSRst, and chkMemEn denote the photodetector voltage (photodetector output signal 112), self-reset triggering signal (trigger output signal 212), and memory enable signal (latch output signal 312), respectively. Most significant bit (MSB) time information is stored in the in-pixel memory (data storage 400) at the first self-reset triggering, and is read out before second Preset signal initializes the memory for least significant bit (LSB) time information. The actual LSB information is calculated by subtracting the second time information from the MSB time information. Thus MSB information can be acquired from the width of the chkMemEn output directly, and LSB information can be calculated by the MSB information and the residual time information.

Simulations for the exemplary embodiment of CMOS image sensor integrated circuit 1 have shown an integration time of 51.2 μs, MSB time of 11.85 μs, and the LSB residual time of 8.174 μs, respectively. This is equivalent to 4.32 times voltage swing. Hence, the total integrated signal is simply calculated by reading the time information twice without the sampling or complicated readout procedure of prior CMOS image sensor designs. Each self-reset takes place during only about 4.56 ns and the integration voltage swing is 2.9 V at V_{ref}=0.4 V.

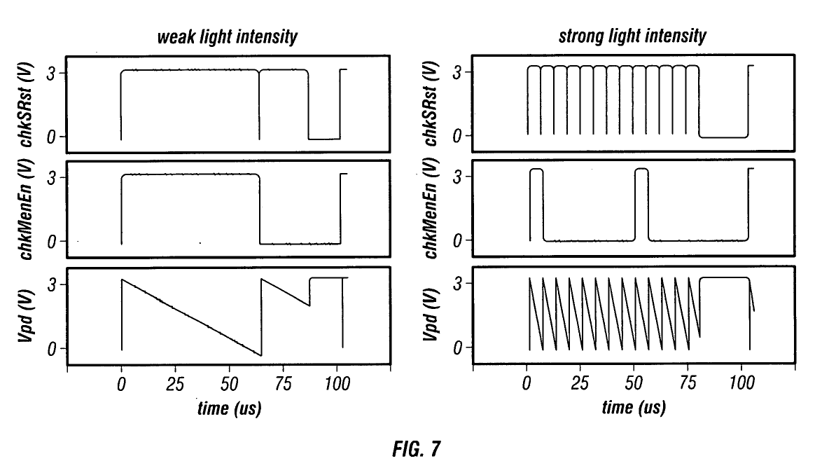

FIG. 7 presents a comparison of simulation results from an embodiment of the CMOS image sensor IC that is exposed to weak intensity and to strong intensity light signals. Again, Vpd, chkSRst, and chkMemEn denote the photodetector voltage (photodetector output signal 112), self-reset triggering signal (trigger output signal 212), and memory enable signal (latch output signal 312), respectively. Stronger light intensity signals provide more frequent self-resets (see chkSRst) and a narrower memory enable pulse (see chkMemEn).

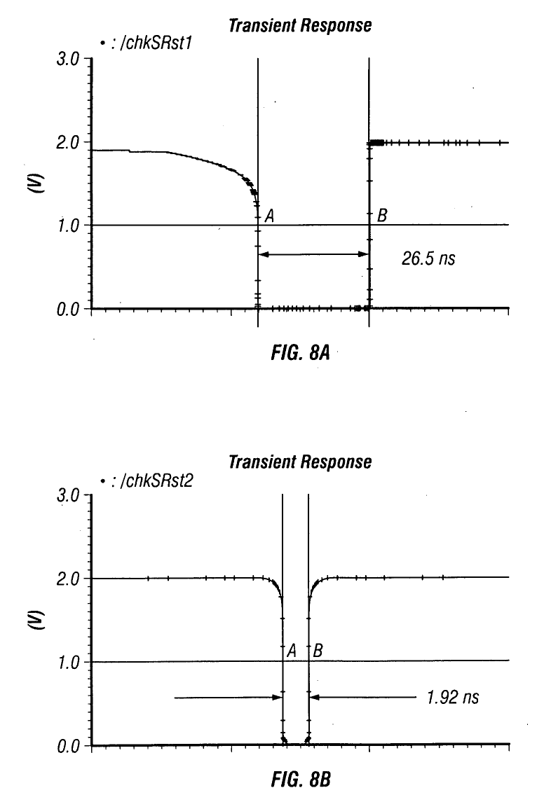

This approach has many useful features for pixel-level self-reset image sensors. For example, it removes the need for additional regenerative circuit blocks in order to reduce self-reset time delay, (e.g., V_{offset1} in FIG. 1), and removes redundant circuit components in the pixel. This allows the timing delay to be reduced. Simulations of circuits using SPICE software for devices fabricated with a 0.5 μm CMOS process show that the delay can be reduced to the order of several nanoseconds, which is approximately 50 times faster than that of the comparator and regeneration blocks of previous work. FIGS. 8A and 8B present a comparison of the 26.5 ns reset delay time of a prior comparator-based method (FIG. 8A) and the 1.92 ns self-reset delay time of an embodiment of the present methods (FIG. 8B). The delay times of both figures is based on simulations of devices implemented using 0.18 μm CMOS fabrication technology.

Another useful feature is that the offset between hard global reset and soft self-reset, (V_{offset2} in FIG. 1), is removed using only one reset switch which is located at the end of the Schmitt trigger (trigger 200) output. This allows the same transient behavior under both global reset and self-reset operations. This is important because for the above described embodiment, the total number of resets is calculated by the first self-reset time information. However, in other embodiments, multiple reset times can be measured and used.

Furthermore, low power operation and wide input swing are available due to dynamic behavior of the inverter-based Schmitt trigger CMOS image pixel circuit 10 in CMOS image sensor integrated circuit 1. Other comparator-based self-reset pixel circuits typically work in saturation and consume larger power during signal integration. If these other circuits are working in the sub-threshold region, there exists a threshold mismatch problem which yields comparator offset and fixed pattern noise (FPN). In contrast, the Schmitt trigger CMOS image pixel circuit 10 of CMOS image sensor integrated circuit 1 consumes only dynamic power. For example, a CMOS image sensor integrated circuit 1 having a 32×24 array of CMOS image pixel circuits 10 was fabricated and found consume 3.9 μW of power per pixel (calculated by dividing the total average power by the number of pixels).

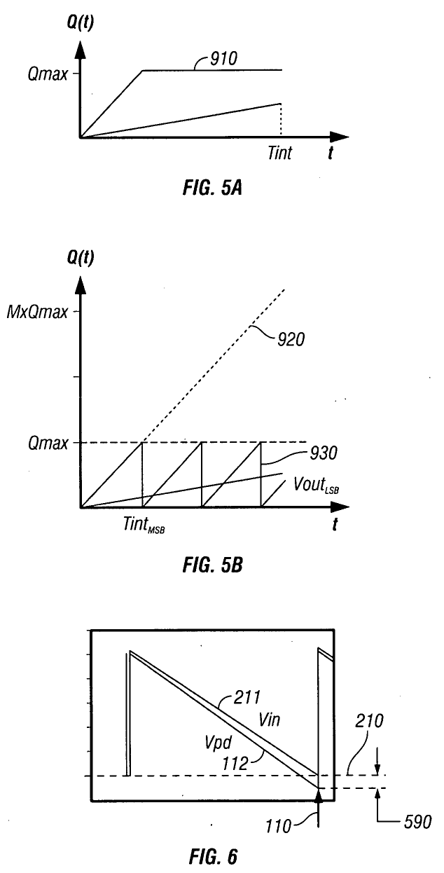

FIGS. 5A and 5B illustrate the operation of a prior photodetector operating in saturation contrasted with the operation of self-resetting embodiments of the present disclosure. FIG. 5A depicts the photodetector saturated charge 910 in saturation due to the well capacity of the photodetector being reached. FIG. 5B depicts the improved dynamic range that is achievable by embodiments of CMOS image sensor integrated circuit 1 containing CMOS image pixel circuit 10. In these embodiments, CMOS image pixel circuit 10 may reset the photodetector prior to self-resetting charge 930 reaching saturation. Calculated aggregate charge 920 can be determined from information related to the photodetector reset, as described above.

### Description of Method Steps Performed by Device Embodiments

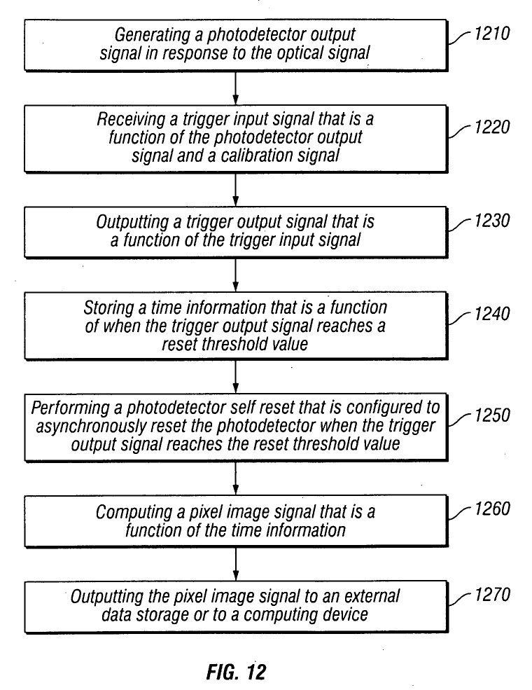

Some embodiments of the present devices are configured to perform the steps of the present methods depicted in FIG. 12 to characterize an optical signal. Referring also to FIG. 2, in these embodiments photodetector 100 may be configured for generating a photodetector output signal in response to the optical signal (step 1210), where in response to optical signal 111, photodetector 100 generates photodetector output signal 112.

Trigger 200 may be configured for performing the step of receiving a trigger input signal that is a function of the photodetector output signal and a calibration signal (step 1220), where trigger input signal 211 is a signal output by offset compensator 500, and is a function of photodetector output signal 112 and calibration signal 510. Offset compensator 500 may receive photodetector output signal 112 and produce trigger input signal 211 that includes an offset to photodetector output signal 112 based on calibration signal 510. Trigger 200 may also be configured for outputting a trigger output signal that is a function of the trigger input signal (step 1230), outputting trigger output signal 212 that may be a function of trigger input signal 211 and a trigger threshold value. Trigger output signal 212 may be a value that changes in response trigger input signal 211 reaching the trigger threshold value, with trigger output signal 212 reaching a reset threshold value as a result. In some embodiments, trigger 200 is a Schmitt trigger. Other embodiments may accomplish triggering using other methods.

Trigger 200 may be configured such that trigger output signal 212 responds to trigger input signal 211 asynchronously. “Asynchronously” is used herein to describe that the response of trigger output signal 212 to changes in trigger input signal 211 is not dependent on a clock cycle. For example, if trigger input signal 211 reaches the trigger threshold value between clock cycles, trigger output signal 212 may respond by reaching the reset threshold value before the next clock cycle.

Latch 300 and data storage 400 may be configured for storing a time information that is a function of when the trigger output signal reaches a reset threshold value (step 1240). When trigger output signal 212 reaches a reset threshold value, latch 300 may latch a value for storage in data storage 400. Since the response of trigger 200 is asynchronous, it is possible that trigger output signal 212 reaches the reset threshold value but does not maintain the threshold value until the next clock cycle. Since the process of storing information in data storage 400 may be dependent on events related to the clock cycle, latching may be required to hold a value to be passed to data storage 400 (via latch output signal 312). Time information 410 may be stored in data storage 400 based on the clock cycle in which an appropriate value of latch output signal 312 is passed from latch 300 to data storage 400. In some embodiments, data storage 400 may be a DRAM cell that is part of CMOS image pixel circuit 10. Other embodiments may include data storage 400 that is another form of storage device, and/or that may not be part of CMOS image pixel circuit 10.

CMOS image pixel circuit 10 may be configured for performing a photodetector self reset that is configured to asynchronously reset the photodetector when the trigger output signal reaches the reset threshold value (step 1250). In the embodiment of FIG. 2, when trigger output signal 212 reaches a reset threshold value, a transistor (denoted 610 on the upper left of the figure) operates to enable photodetector 100 to be reset. In this embodiment, trigger 200 outputs trigger output signal 212 asynchronously, and accordingly photodetector 100 is reset asynchronously.

The embodiment of FIG. 2 is a CMOS image pixel circuit 10 that is a part of CMOS image sensor integrated circuit 1. Some embodiments of CMOS image sensor integrated circuit 1 may perform the step of computing a pixel image signal that is a function of the time information (step 1260) within CMOS image pixel circuit 10. In other embodiments, step 1260 may be performed in other areas in CMOS image sensor integrated circuit 1. An example of the performance of step 1260 is described above, and is shown in FIG. 4.

The calculated pixel image signal being determined, the step of outputting an pixel image signal to an external data storage or to a computing device (step 1270) may be performed by CMOS image sensor integrated circuit 1 or by CMOS image pixel circuit 10. For example, the pixel image signal may be output to a memory (e.g., RAM, SRAM, DRAM, SDRAM, ROM, EPROM, EEPROM), hard drive, optical drive, floppy disk drive, tape drive, DSP, or computer system.

It should be understood that the operational flow diagram of FIG. 12 is intended only as an example, and one of ordinary skill in the art will recognize that in alternative embodiments the order of operation for the various blocks may be varied, certain blocks may be performed in parallel, and additional operational blocks may be added. Thus, the present methods are not intended to be limited only to the operational flow diagram of FIG. 12, but rather such operational flow diagram is intended solely as an example that renders the disclosure enabling for many other operational flow diagrams for implementing the present methods. For example, step 1240 and step 1250 may be performed in parallel.

### Prototype CMOS Image Pixel Circuit

A prototype embodiment of CMOS image pixel circuit 10 depicted in FIG. 2 was fabricated and tested to evaluate SNR performance of a self-reset CMOS image sensor using a Schmitt trigger with a compensation capacitor. The test chip included a voltage regulator to provide a stable system supply voltage and on-chip capacitors to bypass high frequency noises. The supply voltage for self-reset operation was separated from the rest of system supply voltage to avoid self-reset error. A 3-metal 2-poly 0.5 μm CMOS process was used. The pixel size was 49.8 μm×49.8 μm and the pixel fill factor was 25%. Two transistors were added for calibration switches, resulting in 16 transistors (exclusive of the transistors in the in-pixel memory data storage 400). The compensation capacitor 520 was designed using a poly-to-poly capacitor and its capacitance was calculated to be 97.7 fF. The selected capacitance was relatively large compared to the parasitic input capacitance of a Schmitt trigger to minimize charge redistribution to track the photodiode voltage correctly.

Light intensity was controlled by a ramp power supplier and a combination of passive filters. A CPLD program with a 15-bit internal counter and 1 MHz system clock was used, yielding an integration time of 16.348 ms. The output pulse width was measured directly by two oscilloscopes using 4 to 10 GS/s sampling rates. A logic analyzer performed conditional triggering to measure the output pulse width using a 250 MS/s sampling rate.

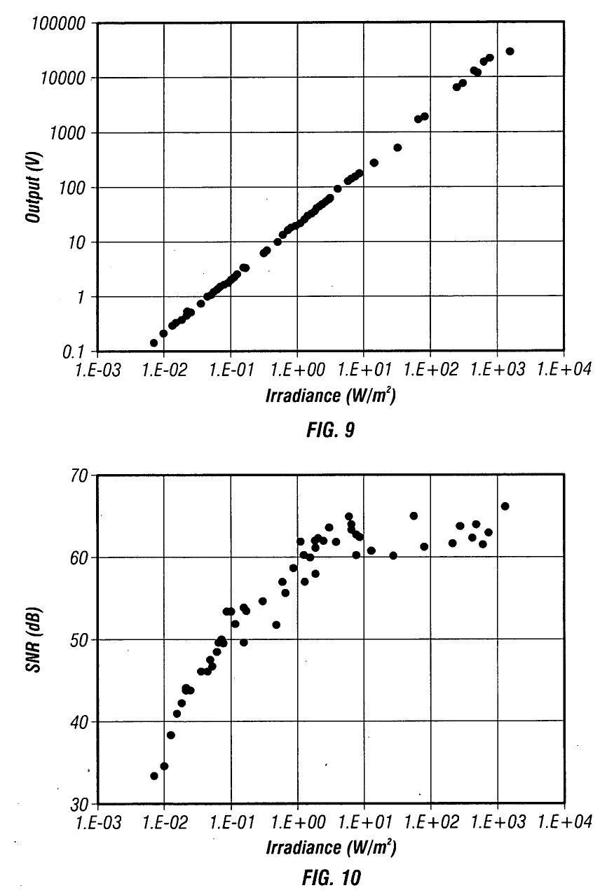

DR performance of the prototype embodiment is shown in FIG. 9. The prototype CMOS image pixel circuit 10 was found to provide 105.6 dB of DR with a linear relationship. The maximum number of self-reset was 9369, equivalent to about 27170 V. The minimum signal was 139 mV.

SNR performance of the prototype is shown in FIG. 10. The first reset was observed at around 0.1 W/m² of irradiance, corresponding to a SNR of 50 dB. As expected from theoretical analysis, the SNR increased at 20 dB per decade for lower light intensity and continued increasing at about 10 dB per decade until the shot noise became dominant over the self-reset noise accumulation. The SNR became saturated beyond about 1 W/m² of irradiance.

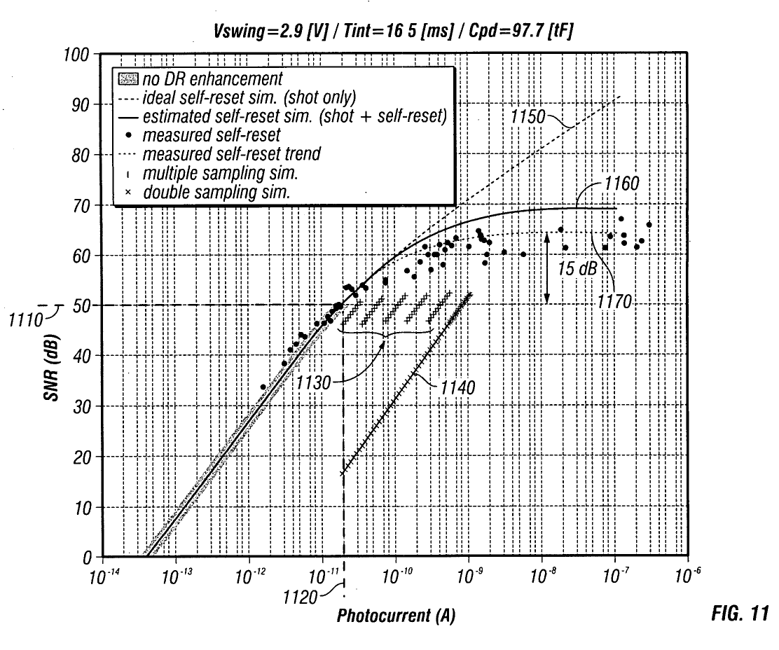

The measured prototype test result are compared with other CMOS image sensors (CIS) in FIG. 11. Simulation results are also shown for comparison, assuming that the photodiode voltage swing range, V_{swing}, is 2.9 V, the integration time is 16.5 ms, and the photocapacitance is 97.7 fF respectively. The x-axis corresponds to DR and the y-axis corresponds to SNR in dB.

A conventional CIS absent any DR enhancement techniques is depicted by a thick line that increases up to about 50 dB (maximum SNR value 1110 and corresponding maximum photocurrent value 1120). There is no additional DR or SNR performance for the conventional CIS above this range.

Simulation of enhancement through additional sampling is depicted by double sampling simulation 1130 and multiple sampling simulation 1140. By using additional sampling, DR can be expanded (dependent on the integration time). However, the SNR performance is limited by the well capacity.

The SNR test results of the prototype embodiment of the CIS pixel is also shown. Ideal self-reset simulation 1150 depicts the ideal self-reset CIS SNR performance without any noise accumulation, including only shot noise, global reset noise, and readout noise. Estimated self-reset simulation 1160 includes these additional modeled noise sources, and shows SNR saturation at 70 dB.

The SNR performance of the prototype embodiment was found to be slightly lower than the simulation result. Measured self-reset 1170 depicts the trend of the measured SNR performance, showing a 15 dB SNR increase over the performance of the conventional CISs. The deviation from estimated self-reset simulation 1160 is believed to be a higher amount of self-reset noise than expect in theoretical derivation, with unstable issues such as digital switching or voltage reference issues affecting the SNR performance. Nevertheless, performance of the prototype self-reset CIS pixel showed the predicted continual SNR increase with expanded DR.

The appended claims are not to be interpreted as including means-plus-function limitations, unless such a limitation is explicitly recited in a given claim using the phrase(s) “means for” and/or “step for,” respectively.

What is claimed is:

1. A CMOS image sensor integrated circuit for characterizing an optical signal, the CMOS image sensor integrated circuit comprising at least one CMOS image pixel circuit, the CMOS image pixel circuit including:
a photodetector configured to generate a photodetector output signal in response to the optical signal;
a trigger coupled to the photodetector, the trigger configured to receive a trigger input signal that is a function of the photodetector output signal, and to output a trigger output signal that is a function of the trigger input signal; and
a latch coupled to the trigger, the latch configured to store a time information in a data storage that is coupled to the latch, the time information being a function of time required for the trigger output signal to reach a reset threshold value;
where the CMOS image pixel circuit is configured to perform a photodetector self reset that asynchronously resets the photodetector when the trigger output signal reaches the reset threshold value.

2. The CMOS image sensor integrated circuit of claim 1, where the where the trigger is a Schmitt trigger.

3. The CMOS image sensor integrated circuit of claim 1, where the trigger comprises six or fewer transistors.

4. The CMOS image sensor integrated circuit of claim 1, where the CMOS image pixel circuit further includes the data storage.

5. The CMOS image sensor integrated circuit of claim 1, where the photodetector self reset is performed within about 6.2 nanoseconds or less from when the output signal reaches the reset threshold value.

6. The CMOS image sensor integrated circuit of claim 5, where the photodetector self reset is performed within about 4.6 nanoseconds or less from when the output signal reaches the reset threshold value.

7. The CMOS image sensor integrated circuit of claim 1, the CMOS image pixel circuit further including an offset compensator coupled to the photodetector and to the trigger, the offset compensator configured for:
receiving a calibration signal; and
providing an offset between the photodetector output signal and the trigger input signal, where the offset is a function of the calibration signal.

8. The CMOS image sensor integrated circuit of claim 7, where the offset compensator comprises a capacitor.

9. The CMOS image sensor integrated circuit of claim 7, where the CMOS image pixel circuit has 28 or fewer transistors.

10. The CMOS image sensor integrated circuit of claim 7, where the CMOS image pixel circuit has 16 or fewer transistors.

11. The CMOS image sensor integrated circuit of claim 7, where the CMOS image sensor integrated circuit provides signal-to-noise ratio of about 65 dB or higher.

12. The CMOS image sensor integrated circuit of claim 11, where the CMOS image sensor integrated circuit provides signal-to-noise ratio of about 79 dB or higher.

13. The CMOS image sensor integrated circuit of claim 7, where the CMOS image sensor integrated circuit provides dynamic range of about 105 dB or higher.

14. The CMOS image sensor integrated circuit of claim 13, where the CMOS image sensor integrated circuit provides dynamic range of about 120 dB or higher.

15. A CMOS image sensor integrated circuit for characterizing an optical signal comprising at least one CMOS image pixel circuit, the CMOS image pixel circuit including:
a photodetector configured to generate a photodetector output signal in response to the optical signal;
a Schmitt trigger coupled to the photodetector, the trigger configured to receive a trigger input signal that is a function of the photodetector output signal, and to output a trigger output signal that is a function of the trigger input signal;
an offset compensator coupled to the photodetector and to the trigger, the offset compensator configured for:
receiving a calibration signal; and
providing an offset between the photodetector output signal and the trigger input signal, where the offset is a function of the calibration signal;
a latch coupled to the trigger; and
a data storage coupled to the latch, where the latch is configured to store a time information in the data storage, the time information being a function of time required for the trigger output signal to reach a reset threshold value;
where the CMOS image pixel circuit is configured to perform a photodetector self reset that asynchronously resets the photodetector when the trigger output signal reaches the reset threshold value.

16. The CMOS image sensor integrated circuit of claim 15, where the photodetector self reset is performed within about 6.2 nanoseconds or less from when the output signal reaches the reset threshold value.

17. The CMOS image sensor integrated circuit of claim 15, where CMOS image pixel has 28 or fewer transistors.

18. The CMOS image sensor integrated circuit of claim 15, where the CMOS image sensor integrated circuit provides a dynamic range of about 105 dB or higher and a signal-to-noise ratio of about 65 dB or higher.

19. A method for characterizing an optical signal received by a photodetector comprising the steps of:
generating a photodetector output signal in response to the optical signal;
receiving a trigger input signal that is a function of the photodetector output signal and a calibration signal;
outputting a trigger output signal that is a function of the trigger input signal;
storing a time information that is a function of when the trigger output signal reaches a reset threshold value;
performing a photodetector self reset that is configured to asynchronously reset the photodetector when the trigger output signal reaches the reset threshold value;
computing a pixel image signal that is a function of the time information; and
outputting the pixel image signal to an external data storage or to a computing device.

20. The method of claim 19, where:
the photodetector self reset is configured to asynchronously reset the photodetector within about 6.2 nanoseconds or less from when the output signal reaches the reset threshold value.
